(19) United States
(12) Patent Application Publication
(10) Pub. No.: US 2011/0074263 A1
(43) Pub. Date: Mar. 31, 2011

(54) HOUSEHOLD APPLIANCE WITH A DOOR COMPRISING A BRAKING DEVICE

(75) Inventors: Klaus Engel, Sinsheim (DE); Christine Linke, Gundelfingen (DE); Alexander Rupp, Prov Jiangsu (CN)

(73) Assignee: BSH BOSCH UND SIEMENS HAUSGERÄ¤TE GMBH, Munich (DE)

(21) Appl. No.: 12/995,492

(22) PCT Filed: Jun. 2, 2009
(86) PCT No.: PCT/EP2009/056721

§ 371 Date: Dec. 1, 2010

(30) Foreign Application Priority Data
Jun. 2, 2008 (DE) 10 2008 026 383.4

(51) Int. Cl. E06B 3/40; F25D 23/02

(52) U.S. Cl. 312/405; 49/381

(57) ABSTRACT

A household appliance including a door that tilts about a tilt axis; a braking device to dampen a tilt motion of the door; and a transferring unit to transfer rotation of the tilt axis to a braking axis during the tilt motion of the door. The braking axis is offset relative to the tilt axis and the braking device is in functional cooperation with the braking axis.

The present invention relates to a household appliance, in particular a refrigeration appliance such as a refrigerator, with a door that can tilt about a tilt axis, and with a braking device for damping the tilt motion of the door.

In the case of household appliances, in particular such as refrigerators, the provision of so-called door-in-door-solutions is increasingly called for as a means of improving energy efficiency, in which an additional door is provided in the actual door of the refrigerator, such as for example of a refrigerator, in order to enable access to a drinks compartment or to a rack for drinks attached to the inside face of the main doors independently of opening of the “main doors”. As in the case of such solutions it is no longer necessary to open the main doors and warm air can thereby no longer flow into the refrigerator, less cooling power and thus less energy is required overall.

In order not to spoil the esthetics of such door-in-door solutions by the addition of a further handle, the smaller door arranged within the main doors is generally provided with a so-called push-push mechanism, in the case of which both opening of the door and its closure by means of simple pressure exerted on the edge region of the door, for example by the hand of a user. A spring is as a rule required for functioning of the push-push mechanism, which effects or at least assists the autonomous opening of the door from its closed position—in opposition to the direction of pressure exerted by the hand. This can, however, lead to problems in that as it is not firmly held by a user by means of a handle, the door performs an uncontrolled and excessively rapid movement. This problem then arises in particular if the tilt axis of the door is arranged horizontally, and the movement of the door increases in force upon opening as a result of gravity. In order to prevent an excessively rapid movement of this kind, U.S. Pat. No. 7,059,693 B2 proposes the attachment of a damping unit to the door, in which a rotating element in an oil-filled container serves to damp the movement of the door. In practice, however, is has proved difficult to mount a damping unit to act on the door, in light of the restricted space available.

The present invention is based on the problem of avoiding the problem associated with the prior art, and creating a household appliance, such as, in particular, a refrigerator, in which a damping unit or braking device for damping the tilt motion of the door provided, which not only works reliably, but can also be readily installed, despite the limited space available.

This problem is solved with a household appliance according to claim 1. Advantageous developments of the invention are the subject of the dependent claims.

The inventive household appliance comprises a door which can be tilted about a tilt axis and a braking device for damping the tilt motion of the door. The invention is characterized in that a transferring unit for transferring the rotation of the tilt axis to a braking axis during the tilt motion of the door is provided, said braking axis being offset relative to the tilt axis, and that the braking device is here in functional cooperation with the braking axis. In other words the braking device does not act directly on the door, but on the transferring unit. The braking device can thereby be installed in a position optimally tailored to the prevailing space, which would otherwise be particularly difficult to realize in the immediate vicinity of the moving door. It should here be noted that the terms “tilt axis” and “braking axis” should not simply be understood as to refer to the actual physical embodiment of such an axis, for example in the form of a shaft, but that they are to be understood in the abstract sense of the word “axis”. This means that any form of the embodiment of such an axis should be encompassed by these terms, so that the rotational motion of the door is transferred from its tilt axis to another axis designated as the braking axis, and the braking device acts on this braking axis.

A particularly simple embodiment of the invention then arises if the tilt axis comprises a pin or for example two pins at the end of the door, and the transferring unit is made up of a multiplicity of toothed wheels, the first of which is connected in a torque-free or non-slip manner with one of the pins and the last of which is connected in a torque-free manner to the braking device. Such an embodiment is easily realizable from the mechanical perspective and cheap to manufacture, as the toothed wheels are available off the shelf and are thus reasonably priced.

The braking effect can be apportioned particularly effectively, if the last toothed wheel is placed underneath the first toothed wheel; in other words the last toothed wheel has a greater pitch circle than the first toothed wheel.

An alternative possible realization of the transferring unit takes the form of a universal joint, one end of which is connected in a torque-free manner with a pin as part of the tilt axis and whose other end is connected in a torque-free manner to the braking device.

It is also possible to embody the transferring unit as a belt drive with two belt pulleys and a belt, in which a first belt pulley is connected in a torque-free manner with one pin as part of the tilt axis and a second belt pulley is connected to the braking device in a torque-free manner.

It is particularly preferable to embody the tilt axis in the form of at least one pin connected to the door in a torque-free manner and thereby mounting the door in a pivotable manner on a frame of the household appliance. The transferring unit and the braking device acting on the pin or pins are here located outside the door.

It is alternatively possible to arrange the transferring unit and the braking device with the brake within a cavity inside the door. In order then to be able to mount the door on a frame, the at least one pin forming the tilt axis is preferably connected to the frame in a torque-free manner. With this embodiment it is thus possible to use the space within the door to accommodate the transferring unit and the braking device.

A particularly expedient application of the invention then emerges if the door is built into an even larger door—also known as a main door—of the household appliance, where the larger door can tilt preferably about a essentially vertically arranged door tilt axis. This larger door is, for example, a “normal” door of a freezer or refrigerator, which is laterally jointed. It is here particularly advantageous if the tilt axis of the small door is essentially horizontally arranged, and the door is thus opened by being swung downwards. In this case “essentially” vertically or horizontally mean only that the precise alignment in a particular orientation is not the critical factor, but that tolerances stemming from manufacture or uneven setting-up of the appliance concerned may apply, without this impairing the functional capability of the invention.

The present invention is then simple to realize, if the transferring unit acts upon the tilt axis of the door, and not on a point offset relative to the tilt axis. Accordingly in this embodiment only the rotational movement need be transferred and it is not necessary also to transfer or compensate translation components, as would be the case were the transferring unit to act upon a point outside the tilt axis.

A particularly simple, reliably operating and cost-effective braking device is produced by a friction-braked piston movable within a cylinder. Braking devices of this kind are available on the mass market and are, for example, manufactured by ITW-Ateco GmbH. In the case of such braking devices a piston made out of for example Minlon® rotates in a housing manufactured for example from Delrin®, damped by the viscosity of a liquid introduced between the two.

Further advantages, features and characteristics of the invention are evident from the following description of an advantageous embodiment of the invention. Where:

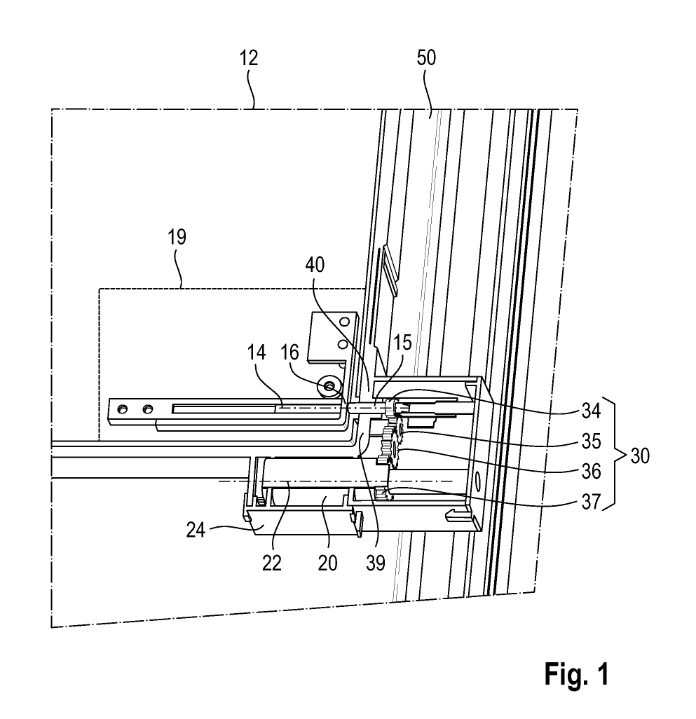

FIG. 1 shows a three-dimensional representation of an advantageous embodiment of the invention, from the front,

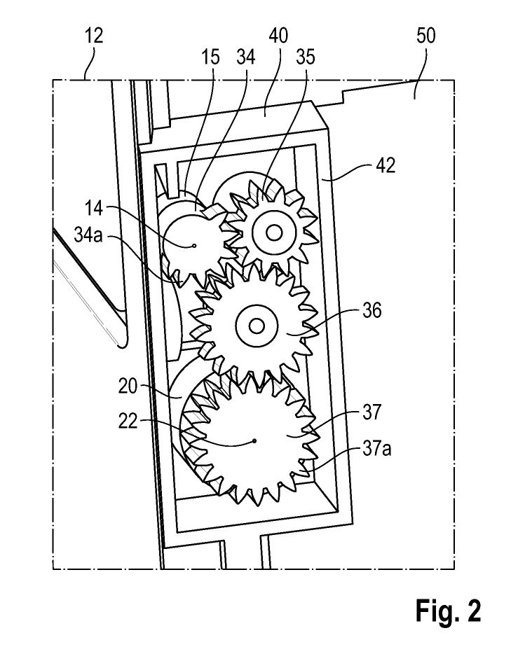

FIG. 2 shows a three-dimensional representation of the advantageous embodiment from FIG. 1, seen from the side,

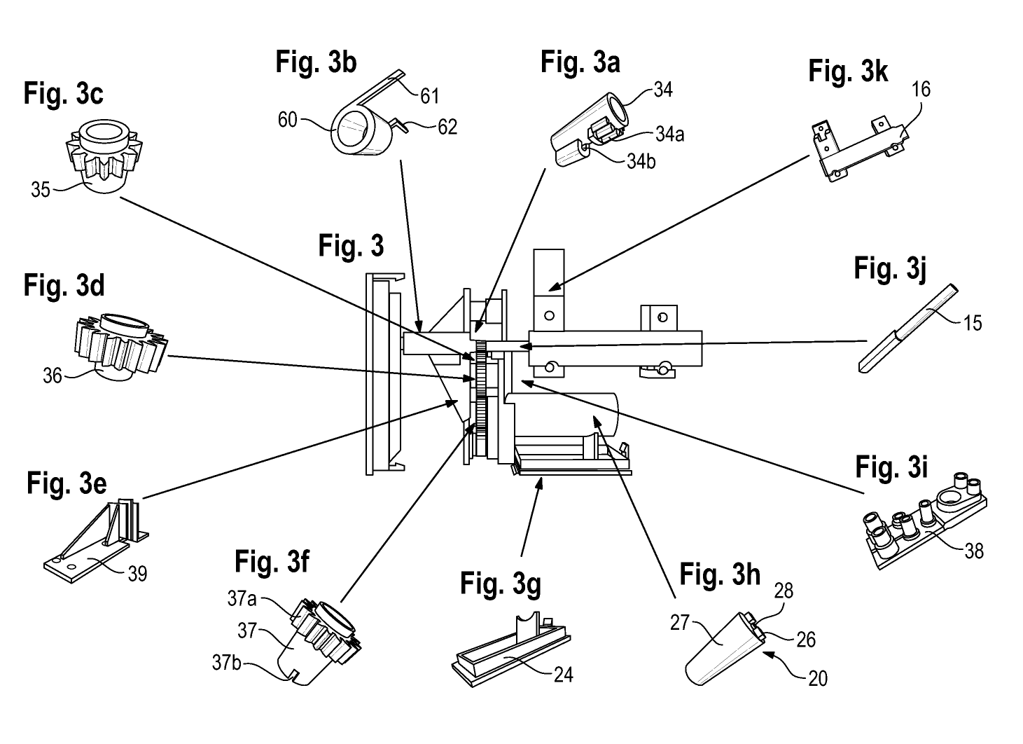

FIG. 3 shows a front view of the advantageous embodiment from FIG. 1, and

FIG. 3a-3k show different components of the embodiment from FIG. 3.

By way of example of the invention there follows a description of a refrigerator with a side-hinged door, into which is built a smaller, additional door, which can be opened and closed in a pivotable manner about a horizontally arranged tilt axis.

FIGS. 1 and 2 show a (small) door 12 of an inventive household appliance or refrigerator. In the door 12 is a pin 15, which serves as a tilt axis 14, via which a pin seat 16 is connected to the door 12 in a torque-free manner. The pin 15 is mounted in a frame 40 in are large, side-hinged door 50 in a pivotable manner. This can be opened by means of a push-push mechanism (not shown) at the top end of door 12. The opening movement of the door 12 is supported by means of a torsion spring 60 (cf. FIGS. 3 and 3b), which acts upon the door 12 in an open position. Upon opening of the door 12, the pin 15 connected with it in a torque-free manner as well as a first toothed wheel 34 (cf. also FIG. 2) pushed onto the pin in a torque-free manner rotate. According to the representation in FIG. 2 the first toothed wheel 34 comprises just some teeth 34a on one side of the circumference. Of course a multiplicity of teeth can also be present in an area of the circumference or also—if space considerations allow—teeth can be present around the entire circumference. The first toothed wheel 34 intermeshes with a second toothed wheel 35, which intermeshes with a third toothed wheel 36 , which in turn intermeshes with a fourth, last toothed wheel 37 . The toothed wheels 34-37 thus form a transferring unit 30 for transferring a rotational movement of the tilt axis 14 of the door 12 to a braking axis 22, which at the sane time is also the axis of rotation of the last toothed wheel 37 and is offset relative to the tilt axis 14.

It is evident from FIG. 1 and. 2 that the toothed wheel 37 has more teeth 37a than the first toothed wheel 34 (relative to their respective circumference); in other words the fourth toothed wheel 37 has a greater pitch diameter than the first toothed wheel 34. As a result of this the rotational movement of the first toothed wheel 34 is stepped down. The effect of the braking device 20 acting on the last toothed wheel 37 or on its axis 22 can thereby be more precisely apportioned than for example would be the case upon translation of the rotational movement of the first toothed wheel 34.

In this embodiment the braking device 20 comprises a piston 28, which can move in a cylinder 27 and is braked through friction. The piston 28 here has engaging projections 26, which engage in recesses 37b of the last toothed wheel 37 (cf. FIG. 3h) and are thus also rotated upon rotation of the fourth toothed wheel 37. The cylinder 27 on the other hand is held fixedly and in a torque-free manner by means of a brake holder 24. FIG. 3 and the FIGS. 3a-3k show individual components of the inventive refrigerator, either assembled or as the case may be represented in individual form. The pin 15 of the door 12 is fixed in a torque-free manner in a pin seat 16, which forms part of the door. The toothed wheels 34-37 are in each case held in a rotatable manner via a bearing flange 38 and a toothed wheel fixing 39. The torsion spring 60 (cf. FIG. 3b) rests with a first leg 61 on the frame 40 of the door 50, and engages with a second leg 62 in a corresponding recess 34b of the first toothed wheel 34.

By means of the previously described arrangement, upon rotation of the pin 15 connected to the door 12, this rotational movement, which is forced through opening of the door 12 by means of the torsion spring 60, is transferred by means of the toothed wheels 34-37 from the tilt axis 14 running through the pin 15 to the braking axis 22 running beneath said tilt axis 14, which passes centrally through the last toothed wheel 37. The braking device 20 with the piston 28 rotating in the cylinder 27 here lies exactly on the braking axis 22 and thus acts on the rotational movement of the fourth toothed wheel 37 or the braking axis 22 respectively. Through appropriate selection of the pre-tensioning of the torsion spring 60 and the damping characteristics of the braking device 20, the arrangement can here be configured in such a way that—after the torsion spring 60 ceases to have an effect as the opening movement of the door 12 progresses and the force of gravity exerts an increasingly greater effect as the door opens ever wider—an uncontrolled, excessively rapid downward movement of the door 12 can be avoided. As the braking device 20 does not or need not act directly on the tilt axis 14 of the pin 15 or door 12, but can also exercise its function on a position offset relative to the tilt axis 14, where space conditions are correspondingly more favorable in form, the total room available can be better used, and the arrangement optimized. A typical example of the cylinder 27 of the braking device 20 is some 50 mm long and has a diameter of 20 mm.

As is evident from FIGS. 1 and 2 in particular, in the case of the previously described embodiment, the braking device 20, the transferring unit 30 in the form of the toothed wheels 34-37 and the torsion spring 60 and the bearing flange 38 and the toothed wheel fixing 39 are affixed outside the door 12. It is however also possible to provide a cavity 19 in the door, which is indicated by a dashed line, and to arrange these components within the cavity 19. That means that these components are moved/pivoted along with the door in the case of a corresponding movement. The space within the door 12 can thereby be used if desired. In this case, though, the pin 15 must be connected in a torque-free manner to the frame 40 fixedly connected with the large door 50, so that the transferring unit rotates relative to the pin 15. The functionality of the braking device 20 connected via the toothed wheels 34-37 is however not thereby impaired.

The frame 40 can be embodied in such a way that it forms a housing 42 (cf. FIG. 2), which can be closed by means of a cover (not shown). This housing 42 can then be cast round with foam material in the course of the production process for the household appliances, in order to improve the insulation effect of the doors 50, in which the housing 42 is located.

Instead of embodying the transferring unit 30 already described in the form of toothed wheels 34-37, a universal joint or a belt drive with two or more belt pulleys and corresponding belts can also be provided, whereby in an appropriate manner the rotational or tilt motion of the door 12 can be transferred from its tilt axis 14 to a braking axis 22 at a distance from this.

For practical purposes, diecast zinc should be mentioned as a particularly suitable material for the first toothed wheel 34, while the remaining toothed wheels and the other components are preferably manufactured from POM (polyoxymethylene). These components can of course also be produced from milled steel parts or appropriate plastics, if applicable reinforced with glass fiber.

A refrigerator with left-hinged large door and bottom-hinged small door was previously specified as an example of a household appliance according to the invention. The invention can of course also be used in other types of household appliances, in which such a door-in-door or similar arrangement is desired.

It should be recorded that the features of the invention, such as for example the design, shape and material of the transferring unit and the braking device as well as their arrangement described with reference to the embodiment represented can also be present in the case of other embodiments, except if otherwise specified or not feasible on technical grounds.

### LIST OF REFERENCE CHARACTERS

12=(Small) door
14=Tilt axis
15=Pin
16=Pin seat
19=Cavity
20=Braking device
22=Braking axis
24=Brake holder
26=Catch projection
27=Cylinder
28=Piston
30=Transferring unit
34=First toothed wheel 20
34a=Tooth
34b=Recess
35=Second toothed wheel
36=Third toothed wheel
37=Fourth toothed wheel
37a=Tooth
37b=Recess
38=Bearing flange
39=Toothed wheel fixing
40=Frame
42=Housing
50=(Large) doors
60=Torsion spring
61=First leg
62=Second leg

1-11. (canceled)

12. A household appliance, comprising:
a door that tilts about a tilt axis;
a braking device to dampen a tilt motion of the door; and
a transferring unit to transfer rotation of the tilt axis to a braking axis during the tilt motion of the door, wherein the braking axis is offset relative to the tilt axis, and wherein the braking device is in functional cooperation with the braking axis.

13. The household appliance of claim 12, wherein the household appliance is a refrigerator.

14. The household appliance of claim 12,
wherein the tilt axis comprises a pin;
wherein the transferring unit comprises a plurality of toothed wheels;
wherein a first toothed wheel of the plurality of toothed wheels is connected to the pin in a torque-free manner; and
wherein a last toothed wheel of the plurality of toothed wheels is connected to the braking device in a torque-free manner.

15. The household appliance of 14, wherein the last toothed wheel is stepped down relative to the first toothed wheel.

16. The household appliance of claim 12, wherein the tilt axis comprises a pin; wherein the transferring unit comprises a universal joint; wherein one end of the universal joint is connected to the pin in a torque-free manner; and wherein the other end of the universal joint is connected to the braking device in a torque-free manner.

17. The household appliance of claim 12, wherein the tilt axis comprises a pin; wherein the transferring unit comprises a belt drive with two belt pulleys and a belt;
wherein a first belt pulley of the two belt pulleys is connected to the pin in a torque-free manner and a second belt pulley of the two belt pulleys is connected to the braking device in a torque-free manner.

18. The household appliance of claim 14, further comprising a frame, wherein the door is mounted on the frame in a pivotable manner and the pin is connected to the door in a torque-free manner.

19. The household appliance of claim 14, further comprising a frame, wherein the door is mounted on the frame in a pivotable manner; wherein the door encloses a cavity; wherein the pin is connected to the frame in a torque-free manner; and wherein the transferring unit, the braking device and the braking axis are arranged within the cavity.

20. The household appliance of claim 12, wherein the door is built into a larger door of the household appliance; and wherein the larger door tilts about an essentially vertically arranged door tilt axis.

21. The household appliance of claim 12, wherein the tilt axis is essentially horizontally arranged.

22. The household appliance of claim 12, wherein the transferring unit acts on the tilt axis.

23. The household appliance of claim 12, wherein the braking device is formed by a friction-braked piston that moves within a cylinder.
